(19) United States
(12) Patent Application Publication
(10) Pub. No.: US 2008/0122220 A1
(43) Pub. Date: May 29, 2008

(54) LOTTERY TICKET WITH TAGGANT DETECTION OF SCRATCHOFF

(76) Inventors: Michael John Brickwood, Winnipeg (CA); Lyle Harold Scrymgeour, Oakbank (CA); Dion Grotkowski, Pickney, MI (US); Andrew Wojtowicz, Winnipeg (CA); Gerald Cormier, Winnipeg (CA)

Correspondence Address: ADE & COMPANY INC., 2157 Henderson Highway, WINNIPEG, MB, R2G1P9, omitted

(21) Appl. No.: 11/942,853

(22) Filed: Nov. 20, 2007

Related U.S. Application Data
(60) Provisional application No. 60/867,509, filed on Nov. 28, 2006.

(51) Int. Cl. B42D 15/00

(52) U.S. Cl. 283/100; 283/72

(57) ABSTRACT

A lottery ticket has a covering scratch-off coating applied over at least part of a game area, including game data applied over an ink layer including a lily pad. A detectable taggant additive material is admixed in an ink of the ink layer having the characteristic of being detectable by a detection scanner when applied over the substrate where the covering scratch-off coating masks the ability of the detection scanner to detect the detectable taggant additive material through the covering scratch-off coating. The scanning of the game area is used to detect areas where the scratch is removed in order to confirm that the game has been played or to detect patterns of removal in a probability type game.

This application claims the benefit under 35 U.S.C. 119 of the filing date of the Provisional Application Ser. No. 60/867,509 filed Nov. 28 2006.

This invention relates to a lottery ticket and to a method of authenticating a prize on a lottery ticket.

### BACKGROUND OF THE INVENTION

Scientific Games Inc have developed and sold authentication machines for scanning and analyzing lottery tickets so as to allow the authentication of a prize value for a scanned ticket. The reason for providing such machines is to reduce the possibility for clerk error or fraud in the validation process. Thus in predetermined tickets, otherwise known as “Instant Win” tickets the ticket carries a numerical code which identifies whether the ticket is a winning or losing ticket as is predetermined by the printing control system. However it is necessary to ensure that the ticket has indeed been played since otherwise unscrupulous retailers can scan un-played tickets to extract the winners. The scanning system therefore must also detect not only the code, commonly a barcode, but must also detect whether the scratch-off material has been properly removed indicating that the ticket has been played.

One technique used by this company is to detect the conductivity of the ticket since the scratch-off material is conductive while the substrate where the scratch-off is removed is not conductive.

This technique has faced some technical difficulties.

In U.S. Pat. No. 5,599,046 (Behm et al) assigned to Scientific Games Inc is disclosed a validation system of lottery tickets of this type which uses electrical circuit elements printed on the ticket underneath the scratch-off material and a scanner which detects the circuits to show where the scratch-off material has been removed.

In U.S. Pat. No. 6,155,491 (Ducker) assigned to Welch Allyn Data Collection Inc is disclosed a similar system which scans the entire top surface of the ticket and provides materials embedded in the scratch-off layer which emit radiant energy and thus can be optically scanned to determine the location of the remaining portions of scratch-off material.

In U.S. Pat. No. 6,875,105 (Behm et al) assigned to Scientific Games Inc is disclosed a validation system for probability lottery tickets. Such tickets give the player the possibility to select amongst a number of locations on the ticket so that the selections determine whether the ticket is a winning ticket or a losing ticket. Such tickets are thus not predetermined. Probability tickets have not been accepted generally In view of the difficulty of analyzing and authenticating winning and losing tickets. In this patent, the analysis also includes detecting which locations on the ticket have had the scratch-off material removed so as to determine the selections made by the player.

Scientific Games Inc has disclosed a validation system where the substrate underneath the scratch-off layer is printed with a pattern of dots which are arranged in a predetermined arrangement indicative of a code. The pattern of dots is used to detect the locations where the scratch-off material has been removed and the code is used as part of the validation number to be analyzed by the computer control system with the bar code printed on the ticket. US2006/0180673 (Finnerty et al) published Aug. 17 2006, which corresponds to WO06/065285 and US2005/025226

U.S. Pat. No. 6,552,290 by Lawandy and assigned to Spectra Systems, describes methods and apparatus for document authentication based on security elements such as fibers, filaments and plachettes that are excited using electromagnetic radiation within a narrow band of wave length. Some of the arrangements described in this patent may be valuable in the present application and the disclosure of this patent is incorporated herein by reference.

### SUMMARY OF THE INVENTION

It is one object of the invention to provide a lottery ticket and/or a method for use with a lottery ticket which allows the location of the scratch-off coating remaining on the ticket to be determined.

According to one aspect of the invention there is provided a lottery ticket comprising.

a substrate;

a game area on the substrate;

an ink layer applied on the game area including game data printed on the game area;

a covering scratch-off coating applied over at least part of the game area, which coating is arranged to be removable by a player scratching the coating to expose the ink layers including the game data;

a detectable taggant additive material included in the ink layer having the characteristic of being detectable by a detection scanner when applied over the substrate;

the detectable taggant additive material being arranged relative to the covering scratch-off coating such that the covering scratch-off coating masks the ability of the detection scanner to detect the detectable taggant additive material through the covering scratch-off coating.

The games concerned may be instant win type games where the result is entirely predetermined, since such games are generally preferred in a lottery situation in order to ensure that the total winnings is predetermined. However the present invention is not limited to the type of game to be played and can include probability or other games which include game indicia covered by a scratch-off coating.

The construction may also be used in situations where the main objective is for other purposes than gambling such as in promotional games or games of fun for children or others where no gambling or prizes are involved.

Many such tickets are used directly in a lottery situation so that the tickets have no other relevance other than the playing of the lottery or game by which the player may win monetary or other prizes as part of the lottery or gaming situation. However more attention has been recently given to the use of such tickets as promotional items used by manufacturers of other products to enhance the sale of the product.

Preferably the detectable taggant additive material is applied over the whole game area. However it may also be limited to specific locations where the remaining scratch-off material needs to be detected.

The coating material may not be a single homogeneous layer and in most cases will be made up of distinct layers applied on top of one another including latex and inks and other layers as is well known to a person skilled in this art.

The ink layer also generally will not be a single homogeneous layer and in most cases will be made up of distinct layers applied on top of one another including base layers commonly known as “lily pads”, varnishes, security layers, inks and other layers as is well known to a person skilled in this art.

Preferably the detectable taggant additive material is applied in an even layer within the ink layer and is admixed with an ink of the ink layer. In most cases the detectable taggant additive material is applied in a lily pad covering the game area since this comprises a single layer covering the whole area. However other layers or layer can be selected to carry the admixed taggant material. Where the material is applied to the lily pad ink layer, it is highly desirable that it is not masked by the ink layers applied over the lily pad including the game data and is only masked by the covering scratch-off material.

Preferably the detectable taggant additive material is of a character which allows optical detection. Such materials commonly emit light at a predetermined wave length in response to energization by an input energy commonly but not necessarily at another light wavelength. However other taggants are known to persons skilled in the art using various techniques for detection.

Preferably the unique character of the taggant is used to provide an authentication of the ticket. However taggants may be selected which are not unique and merely provide an emission which is uniform over the game area and can be detected and masked as defined.

Preferably the substrate carries a machine readable code, commonly but not necessarily a “barcode”, which can be read by a scanner on the apparatus and arranged to be compared with a list of such codes for determining a prize value of the ticket.

In most cases a part of the code is exposed and a part of the code is covered by a portion of the covering scratch-off coating. This arrangement is a commonly used construction known to provide an acceptable level of security.

While the ticket carries commonly a predetermined game, commonly known as an instant win ticket, the game date may define a probability game where the player can select from certain available features of the game so that some or all of the tickets are potentially winning tickets depending on the selections made by the player. Such tickets are of limited commercial success despite the appeal to the player in view of the difficulty of managing the risk of pay outs being larger than the income. The ability of the present system to accurately detect the places where the scratch-off coating has been removed and where it remains allows the authentication system to ensure that only winning selections are paid out thus retaining accurate probability for the payouts and avoiding or at least reducing the possibility of fraud.

According to a second aspect of the invention there is provided a method of authenticating a prize on a lottery ticket comprising:

inserting into a ticket scanning apparatus having a detection scanner a lottery ticket comprising:

a substrate;

a game area on the substrate;

an ink layer applied on the game area including game data printed on the game area;

a covering scratch-off coating applied over at least part of the game area, which coating is arranged to be removable by a player scratching the coating to expose the ink layers including the game data;

a detectable taggant additive material included in the ink layer having the characteristic of being detectable by the detection scanner when applied over the substrate;

the detectable taggant additive material being arranged relative to the covering scratch-off coating such that the covering scratch-off coating masks the ability of the detection scanner to detect the detectable taggant additive material through the covering scratch-off coating;

scanning the game area with the detection scanner to detect the detectable taggant additive material to provide a determination of parts of the game area which remain covered by the covering scratch-off coating and parts where the covering scratch-off coating has been removed;

and authenticating a prize depending upon the determination.

Preferably the substrate carries a readable code and code is read by a code reader and compared with a list of such codes for determining a prize value of the ticket.

In one arrangement the game is a probability game based on patterns of selected areas for removal of the scratch-off material and the game area is divided into a matrix of separate sections and the sections which remain covered by the covering scratch-off coating and the sections where the covering scratch-off coating has been removed are detected to generate a pattern and the pattern is compared with a list of tickets and the patterns thereon so that a prize is at least in part determined on the pattern.

Taggant materials of many different types are known to persons skilled in that art. For example U.S. Pat. No. 6,165,609: (Curatolo) assigned to Avery Dennison Corporation Security discloses coatings for label materials from about 0.001% to about 5% by weight of at least one taggant compound, wherein the taggant compound is substantially uniformly dispersed within the film forming material, and wherein said taggant compound fluoresces at a known wavelength within the range of 390 nm to 700 nm upon irradiation with ultraviolet light of said label and wherein said taggant is detectable without removing the label from the product.

### BRIEF DESCRIPTION OF THE DRAWINGS

Embodiments of the invention will now be described in conjunction with the accompanying drawings in which:

FIG. 1 is a top plan view of an instant win lottery ticket according to the present invention.

FIG. 2 is a cross sectional view along the lines 2-2 of FIG. 1.

FIG. 3 is a schematic side elevational view of a machine for scanning the ticket of FIG. 1.

FIG. 4 is a top plan view of a probability lottery ticket according to the present invention.

In the drawings like characters of reference indicate corresponding parts in the different figures.

### DETAILED DESCRIPTION

Further information concerning lottery tickets and methods for printing them is disclosed in prior United States patents of the present assignee, the disclosure of which is incorporated herein by reference, as follows:

U.S. Pat. No. 6,145,885 issued Nov. 14 2000;

U.S. Pat. No. 6,234,477 issued May 22 2001; and

U.S. Pat. No. 6,347,794 issued Feb. 19 2002.

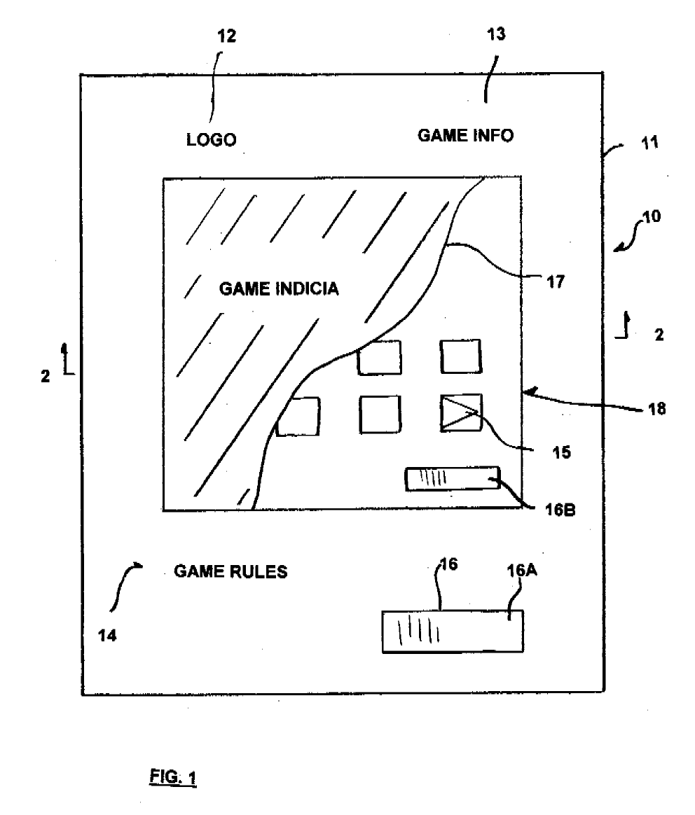

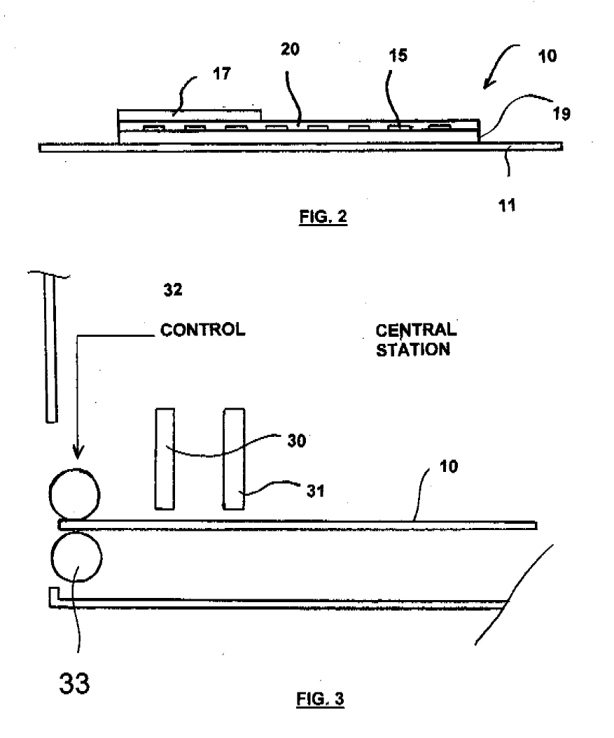

In FIGS. 1 and 2 is shown a lottery ticket generally indicated at 10 which is of the instant win ticket type so that the winning or losing status of the ticket is entirely predetermined and the playing of the game merely requires the player to expose the game data thus revealing to the player the winning or losing status. Such tickets are well known and widely used and of course require that the player be able to quickly authenticate the prize value which has been revealed to the player.

Such tickets generally are performed by a substrate 11 on which is printed common information including a game logo 12 and various game information 13 together with a set of game rules indicated at 14. In addition each game carries a set of game indicia generally indicated at 15 which is printed by a variable imaging computer system so that the game indicia for each ticket is different from that of many other tickets or all other tickets as required. In addition such tickets generally carry a bar code indicated at 16. On top of the game indicia is applied a scratch-off coating 17.

Such tickets are commonly known and widely used. A manufacturing process is controlled so as to provide security for the ticket by selecting materials for the substrate, for overlying ink layers on the substrate, for the game data, for covering layers and for the scratch-off coating. Each of these layers maybe provided by a single layer of the material concerned or may be more complex including multiple layers as is well known to a person skilled in the art.

In particular in the arrangement shown, the substrate 11 is covered in an initial layer at the game area generally indicated at 18 by a base ink layer indicated at 19. Commonly this base layer is termed a “lily pad” which is a single color or white layer of ink which provides a base on the substrate for receiving the subsequent layers. The lily pad can provide security to inhibit reading of the game data through the rear of the substrate.

On top of the base layer 19 is provided the game indicia 17 which is provided as a variable imaged printed layer of indicia which constitute the characteristics of the game as identified by the game rules 14.

Over the game indicia 17 is provided a further ink layer 20 which includes various seal coats and varnishes which ensure that the game data is properly protected and maintained integral on the lily pad 19 and provides a support for the scratch-off layer 17 so that it can be readily removed by the player.

In the embodiment shown the bar code 16 is separated into two sections 16A and 16B where one part 16A is exposed on the front of the ticket at a location separate from the scratch-off coating 17 and a second part 16B is applied onto the game area underneath the scratch-off coating so as to be maintained against viewing until the game is played. However in the alternative all of the bar code 16 can be placed on the open part of the ticket or all in the area underneath the scratch-off as required and as know to a person skilled in the art.

The bar code may be a one dimensional bar code or two dimension bar code as is well known to a person skilled in this art. Selection of the bar code depends upon the amount of information to be stored relative to the area available to receive the information. The term “bar code” is intended to include other machine readable codes using various machine decoding techniques as is well known to a person skilled in the art including generally the term “optical character recognition” or OCR.

In the embodiment disclosed herein, one or all of the ink layers underneath the scratch-off coating 17 contains a taggant material. This is preferably applied in the base layer 19 or “lily pad” and the taggant material is applied into the ink in admixture therewith in an intimately mixed material so that the material is evenly spread through out the ink layer.

Taggant materials are generally particles which can be admixed with ink at a suitable ratio so that sufficient of the particles are laid in the ink to allow detection by a scanner applied over the ink layer carrying the taggant material. Many taggant materials are of the type which emit energy, generally light energy at a particular wave length in response to excitation by an applied energy at a different wave length.

However other taggant materials are also known which emit other radiations which can be detected generally in response to excitation. The techniques for excitation can also vary as are well known to one skilled in the art.

Taggants can be carefully selected for the lottery tickets which are different from other taggants used for other lottery tickets so as to properly identify the ticket concerned. The taggant can in this arrangement therefore be used as a security feature so that counterfeiting of the tickets can be avoided. In other cases the taggant material selected may be simply of a nature which is not itself an identification of a particular material and is not used to identify the ticket concerned but is merely used as a technique for emitting a detectable emission which can be observed in a scanner passed over the game area 18 of the ticket.

The taggant is selected relative to the characteristics of the scratch-off coating layer 17 so that the emissions of the taggant material are masked and are prevented from reaching the scanner in the presence of scratch-off coating.

In this way the presence of the taggant material in the underlying layer underneath the scratch-off coating can be used to detect the presence or absence of the scratch-off coating over the complete area of the game area 18. Depending upon the amount of taggant material in the ink and the resolution of the scanner, the presence or absence of the scratch-off coating in particular areas of the total game area can be analyzed to determine a pattern of the scratch-off coating which has been removed. This pattern can be used in analysis of the authenticity of the ticket and the proper presentation of a properly played ticket where the game has been played by the removal of the scratch-off coating to an extent which shows the game has been played. In this way if only a small part of the scratch-off coating has been removed in an attempt to expose the game data without actually playing the game by removing large parts of the scratch-off coating, this can be detected by the scanning system. The amount of taggant material can be selected so that it can detect the removal of only small parts of the scratch-off coating or removal of substantially all or situations where parts of the scratch-off coating remain in place. The resolution can be determined by the manufacturer depending upon the scanner and the amount of taggant material in accordance with the requirement for resolution in the scanning system.

Turning now to FIG. 3, there is shown schematically a scanning machine which receives the ticket 10 and passes through a pair of scanners 30 and 31 under control of a control system 32 and driven by a motor and roller drive system 33.

Thus the ticket is inserted into the rollers by the player or by a clerk at the validation station. The ticket is grasped by the rollers and driven at a predetermined rate past the scanners 30 and 31.

The scanner 30 is a bar code scanner selected to read the type of bar code selected at the bar code 16 printed on the ticket. Typically such scanners are laser scanners. The location of the scanner is arranged so that the carrying of the ticket through the rollers passing the scanner over the bar code area.

The scanner 31 is a scanner which is used to detect the emissions of the taggant material and at the same time to provide the excitation necessary to elicit those emissions. The scanner is arranged in an array across the ticket with a series of individual scanning elements across the array so as to scan the full width of the ticket, with the control system being arranged relative to the driving system 33 so that a matrix can be generated of excitation levels over an array of pixels on the game area 17.

Thus these tickets are inserted into the machine and passes through the scanning process so as to detect the bar code information and the presence or absence of the scratch-off coating at certain areas of the total game area 18.

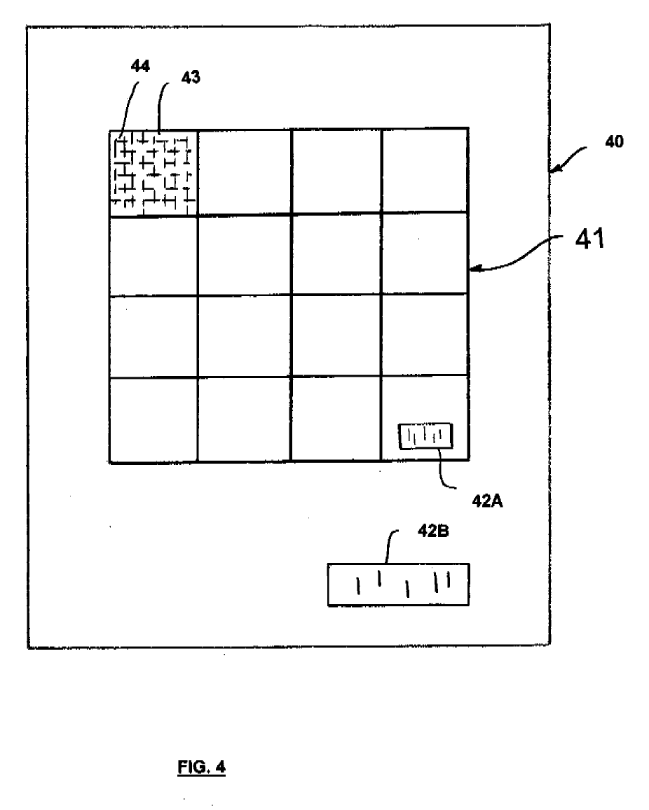

Turning now to FIG. 4, there is shown a probability game ticket indicated at 40 which includes a game area 41 and a bar code divided into two bar code portions 42A and 42B as previously described. These bar code portions can be formed into a single bar code either on the exposed part of the ticket or on the scratch-off covered part of the ticket as required. In a common probability type game, the game area is individual areas in a matrix which in the example shown is a 3×4 maintenance having three columns and four rows. In the probability game, the player can select particular sections of the game areas of the matrix and can scratch-off the coating at that area to expose the game indicia selected by the player.

In many probability games, each ticket can be a winner depending upon the areas selected by the player. In other probability games some of the tickets may necessarily be losers and some tickets are potentially winners with the amount of the prize or existence of the prize being determined by the areas of the matrix selected by the player. In the probability game, the total amount of prizes of the game for all of the tickets sold can of course vary but is based on probability so that large variations can be managed.

The ticket of FIG. 4 is basically of the same construction as that shown in FIGS. 1 and 2 and passes through the machine of FIG. 3. The significant difference is that the scanner 31 is scanning to determine the areas of the matrix which have been scratched relative to those which have not. It is of course essential that the ticket remain intact with only the areas which have been scratched being exposed and the other areas being totally covered since otherwise the security of the ticket is compromised.

Thus as shown in FIG. 4 there is a first matrix element 43 and this is divided into a series of pixels 44 which are generated by the scanner 31 by the array of pixels across the width of the ticket and the gradual movement of the ticket through the scanner. This array can therefore be assessed to determine what proportion of the pixels have the coating removed and which proportion have no coating removed. Using this scanned array, the control system can detect based upon an algorithm apparent to one skilled in the art which of the twelve areas have been scratched or which have little or no scratching occurring. The algorithm can select whether certain ones of the areas of the matrix are sufficiently intact to constitute an unscratched area.

In the probability ticket, therefore, the scanner detects the barcode, either in a single piece or in two pieces and detects which of the areas have been scratched. This information is then transmitted to a central station where the information is compared with a table of tickets to ensure that the ticket is authentic and to determine the prize level which should be paid.

As explained previously in instant win tickets, the winning or losing is determined strictly by the bar code and the detection of the scratch-off coating to provide authentication that the bar code properly applies the ticket concerned and also that the ticket has been properly played.

In probability tickets, the prize to be paid depends upon the bar code and also the information concerning the particular areas of the matrix which have been scratched.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A lottery ticket comprising:
a substrate;
a game area on the substrate;
an ink layer applied on the game area including game data printed on the game area;
a covering scratch-off coating applied over at least part of the game area, which coating is arranged to be removable by a player scratching the coating to expose the ink layers including the game data;
a detectable taggant additive material included in the ink layer having the characteristic of being detectable by a detection scanner when applied over the substrate;
the detectable taggant additive material being arranged relative to the covering scratch-off coating such that the covering scratch-off coating masks the ability of the detection scanner to detect the detectable taggant additive material through the covering scratch-off coating.

2. The lottery ticket according to claim 1 wherein the detectable taggant additive material is applied over the whole game area.

3. The lottery ticket according to claim 1 wherein the detectable taggant additive material is applied in an even layer.

4. The lottery ticket according to claim 1 wherein the detectable taggant additive material is admixed with an ink of the ink layer.

5. The lottery ticket according to claim 1 wherein the detectable taggant additive material is applied in a lily pad covering the game area.

6. The lottery ticket according to claim 1 wherein the detectable taggant additive material is of a character which allows optical detection.

7. The lottery ticket according to claim 1 wherein the substrate carries a readable code arranged to be compared with a list of such codes for determining a prize value of the ticket.

8. The lottery ticket according to claim 7 wherein a part of the code is exposed and a part of the code is covered by a portion of the covering scratch-off coating.

9. The lottery ticket according to claim 7 wherein the code is a bar code.

10. The lottery ticket according to claim 1 wherein the game data defines a probability game.

11. A method of authenticating a prize on a lottery ticket comprising:
inserting into a ticket scanning apparatus having a detection scanner a lottery ticket comprising:
a substrate;
a game area on the substrate;
an ink layer applied on the game area including game data printed on the game area;
a covering scratch-off coating applied over at least part of the game area, which coating is arranged to be removable by a player scratching the coating to expose the ink layers including the game data;
a detectable taggant additive material included in the ink layer having the characteristic of being detectable by the detection scanner when applied over the substrate;
the detectable taggant additive material being arranged relative to the covering scratch-off coating such that the covering scratch-off coating masks the ability of the detection scanner to detect the detectable taggant additive material through the covering scratch-off coating;
scanning the game area with the detection scanner to detect the detectable taggant additive material to provide a determination of parts of the game area which remain covered by the covering scratch-off coating and parts where the covering scratch-off coating has been removed;
and authenticating a prize depending upon the determination.

12. The method according to claim 11 wherein the substrate carries a readable code and code is read by a code reader and compared with a list of such codes for determining a prize value of the ticket.

13. The method according to claim 11 wherein a part of the code is exposed and a part of the code is covered by a portion of the covering scratch-off coating.

14. The method according to claim 11 wherein the code is a bar code.

15. The method according to claim 11 wherein the game area is divided into a matrix of separate sections and the sections which remain covered by the covering scratch-off coating and the sections where the covering scratch-off coating has been removed are detected to generate a pattern and the pattern is compared with a list of tickets and the patterns thereon so that a prize is at least in part determined on the pattern.

16. The method according to claim 15 wherein the scanner is arranged to provide a plurality of pixels of the game area such that each section is scanned to generate an array of pixels for each section.

17. The method according to claim 11 wherein the detectable taggant additive material is applied over the whole game area.

18. The method according to claim 11 wherein the detectable taggant additive material is applied in an even layer.

19. The method according to claim 11 wherein the detectable taggant additive material is admixed with an ink of the ink layer.

20. The method according to claim 11 wherein the detectable taggant additive material is applied in a lily pad covering the game area.

21. The method according to claim 11 wherein the detectable taggant additive material is of a character which allows optical detection.

22. The method according to claim 11 wherein the substrate carries a readable code arranged to be compared with a list of such codes for determining a prize value of the ticket.

23. The method according to claim 11 wherein a part of the code is exposed and a part of the code is covered by a portion of the covering scratch-off coating.

24. The method according to claim 11 wherein the code is a bar code.

25. The method according to claim 11 wherein the game data defines a probability game.
